(19) United States
(12) Patent Application Publication
(10) Pub. No.: US 2025/0354046 A1
(43) Pub. Date: Nov. 20, 2025

(54) THERMAL INTERFACE MATERIAL SYSTEM AND METHOD

(71) Applicant: Purdue Research Foundation, West Lafayette, IN (US)

(72) Inventors: John Alan Howarter, West Lafayette, IN (US); Geeta Pokhrel, West Lafayette, IN (US); Chelsea Davis, Newark, DE (US)

(21) Appl. No.: 19/210,551

(22) Filed: May 16, 2025

Related U.S. Application Data
(60) Provisional application No. 63/648,781, filed on May 17, 2024.

(51) Int. Cl. C09K 5/14; C08K 3/08; C08K 7/00; C08L 53/02; C09D 5/18; C09D 7/40; C09D 7/61; C09D 153/02

(52) U.S. Cl. CPC C09K 5/14; C08L 53/02; C09D 5/18; C09D 7/61; C09D 7/67; C09D 7/70; C09D 153/02; C08K 2003/0831; C08K 7/00; C08K 2201/001; C08K 2201/011; C08L 2205/03; C08L 2207/04

(57) ABSTRACT

The thermal interface material (TIM) system of the present disclosure includes a thermal pad having a thermoplastic elastomeric copolymer coupled to a thermally conductive nanoparticle. The thermoplastic elastomeric copolymer may include glassy and rubbery polymers. In a specific example, the thermoplastic elastomeric copolymer may include a pseudo-bicontinuous morphology of polymer blends, such as polystyrene (PS) and/or polyisoprene (PI). In a more specific example, the thermoplastic elastomeric copolymer may include a triblock copolymer of polystyrene-block-polyisoprene-block-polystyrene (SIS). The thermally conductive nanoparticle may be non-electrically conductive. The thermally conductive nanoparticle may include 2D boron nitride (BN). The thermally conductive nanoparticle may include a metallic filler material such as gold (Au).

### CROSS REFERENCE TO RELATED APPLICATIONS

This application claims the benefit of U.S. Provisional Application No. 63/648,781 filed May 17, 2024, the entirety of which is hereby incorporated by reference.

### FIELD

The disclosure generally relates to thermal interface materials and, more particularly, to compositions for enhanced thermal and mechanical properties.

### INTRODUCTION

This section provides background information related to the present disclosure which is not necessarily prior art.

Recent advancements in microelectronics have led to the physical dimensions of electronics shrinking while becoming more powerful and efficient, increasing the energy density of the devices. Consequently, challenges regarding thermal management are rising. Efficient heat conduction is one of the constraining factors for device reliability and durability. A device's life span decreases by 50% if its operating temperature increases 10-15° C. Thus, efficient heat conduction across component interfaces and protection against chronic overheating is vital.

Thermal interface materials (TIMs) are used to bridge the electronic component surfaces, minimize thermal contact resistance, and increase thermal conductivity. However, TIMs encounter extreme environmental, thermal, and mechanical conditions during their operation, resulting in delamination, voids, cracks, material degradation, or pump-out that hinders thermal conduction. While thermal properties are vital for TIMs, superior mechanical properties are equally needed for electronic functionality and reliability. However, there is a lack of systematic study investigating the balance between mechanical and thermal performance.

Thermal pads can offer good conformability, mechanical performance, and electrical insulation. These are typically fabricated using a silicone elastomeric matrix mixed with thermally conductive fillers and thickness of 0.25-5.00 mm. They can resist harsh operating environments while maintaining sufficient thermal conductivity. Additionally, thermal pads offer some notable advantages over other TIMs. They are not messy to handle, as opposed to thermal greases. They have low modulus, as opposed to solders. Hence, they can expedite the assembly process by efficiently adhering with inherent tack between solid substrates, maintaining stability without pumping out during thermo-mechanical cyclic conditions. Their elastic nature facilitates easy deformation to match solid surface irregularities, returning to original dimensions when cyclic conditions diminish. The compression advantage accommodates tolerance variations in assembly and functions as a vibration damper. Unlike solders, which are soft due to their low melting point for joint reliability, thermal pads are even softer. Likewise, they are electrically isolating, as opposed to carbon-based TIMs.

Traditionally, higher filler volumes of up to 80% are used in thermal pads. From a mechanical perspective, using lower concentrations of fillers is advantageous as higher concentrations can embrittle the composite. Likewise, less fillers can reduce microscopic surface roughness to improve conformal contact and adhesion with flat, rigid surfaces. Silicone is the major polymeric matrix used to reduce filler concentration. In this work we use a different matrix than conventional silicones to reduce filler concentration. However, the use of silicones alone do not provide the necessary balance between thermal conductivity and mechanical robustness.

Accordingly, there is a continuing need for a thermal interface material composition that optimizes both mechanical and thermal performance.

### SUMMARY

In concordance with the instant disclosure, a thermal interface material composition that optimizes both mechanical and thermal performance, has surprisingly been discovered.

The present disclosure uses a different matrix than conventional silicones to reduce filler concentration. The combination of different polymers, in the form of polymeric blends (micrometer domains) or block copolymers/thermoplastic elastomers (TPE) (nanometer domains), hold promise for high-performance applications, with optimized performance relying heavily on morphology. The bicontinuous morphology of immiscible polymer blends, for instance, enhances interfacial area, making the bicontinuous morphology valuable in applications such as organic electronics for efficient hole and electron transport. The phase morphology can be tuned depending on each component concentration, annealing time, and temperature conditions. Bicontinuous polymer blends are commonly fabricated through processes like solution casting or melt blending with both polymer types being glassy and subsequently mechanically brittle. In contrast, the present disclosure has utilized glassy and rubbery polymers with a continuous rubbery phase and investigated the mechanical deformation behavior. We investigated that utilizing a rubbery continuous polymer can produce a mechanically resilient thin film. The rubber can absorb strain energy during mechanical loading, preventing the films from tearing or cracking.

Nanofillers can be incorporated into the glassy-rubbery polymer blends or block copolymers to enhance functional properties such as: thermal conductivity, electrical conductivity, or optical properties. The nanofillers can be selectively localized in one phase, at the interface, or both phases by altering their chemical functionality. Selective localization of nanofillers in one phase especially in the morphologies like lamellar, columnar, bicontinuous (2D) or gyroid (3D) can form percolation pathways at low concentration, lowest reported is 0.11 vol. %, to achieve the same effective thermal performance. Depending on these morphologies, in plane or cross plane thermal conductivity can be enhanced at a lower concentration of nanofillers. Percolation threshold is defined as the critical concentration of nanoparticles which creates a continuous transport pathway. Since lower nanoparticle concentrations are required to make a continuous pathway for heat or electrical transfer, a balance between the mechanical integrity and functional performance can be achieved. Thus, both cost and performance can be optimized by tuning the polymer composition and morphology.

In certain circumstances, the present disclosure may include scalable TIMs that can be fabricated from nanoscale to microns or millimeter thickness depending on the requirements. Fabrication techniques may be different depending on the size scale of TMs.

The present disclosure includes non-limiting examples of fabricating and characterizing thermal pads using a thermoplastic elastomeric triblock copolymer of polystyrene-block-polyisoprene-block-polystyrene (PS-b-PI-b-PS) or immiscible polymer blends of polystyrene and polyisoprene with a continuous polyisoprene (rubbery phase) and dispersed polystyrene (glassy) phase filled with thermally conductive 2D hexagonal boron nitride (BN) nanoplatelets. 2D BN nanoplatelets are functionalized with polydopamine and (3-aminopropyl)trethoxysilane to enhance dispersion and interfacial adhesion of nanoparticles in the polymeric matrix. The polymer blocks typically consist of a stiff phase that can constrain total deformation and a rubbery phase that provides extensibility. In polymer blends, block copolymer is added as compatibilizer and benzophenone that activates under UV Ozone treatment as crosslinker. Due to these components, the overall composite is highly stable and crosslinked. With this robust system, mixing high thermally conductive 2D BN fillers with SIS block copolymers can produce thermal pads with desirable thermal conductivity. The fabricated thermal pads are characterized by studying surface topography, roughness, thermal conductivity, thermal degradation, and mechanical behavior. It was observed that too much increase in nanofiller content negatively impacts mechanical performance without necessarily improving thermal conductivity. Thus, understanding the balance of mechanical and thermal performance is critical for optimization.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a schematic flow diagram illustrating an experimental setup for fabricating the thermal interface material (TIM) system, according to one embodiment of the present disclosure;

FIG. 2 is a series of optical profilometer images illustrating surface topography and surface roughness of samples at 0, 10, 20, 30, and 40 vol. % of boron nitride (BN) in polymeric matrix, according to one embodiment of the present disclosure;

FIG. 3A is a line graph illustrating a TGA curve for different compositions showing weight loss as a function of temperature, according to one embodiment of the present disclosure;

FIG. 3B is a plot diagram of a TGA curve for different compositions showing the onset of degradation temperature versus different amounts of BN, according to one embodiment of the present disclosure;

FIG. 4A is a schematic representation of in plane and cross plane/through plane thermal conductivity in a 3D configuration of thermal pads, according to one embodiment of the present disclosure;

FIG. 4B is a plot diagram illustrating in plane and cross plane k values with standard error bars for thermal pads from 0 to 40 volume percentage, further depicting a decreasing trend at and above 30 volume percentage, according to one embodiment of the present disclosure;

FIG. 5 is a bar graph illustrating the elastic modulus and shore A hardness of thermal pads at different formulations measured from rectangular shaped samples, according to one embodiment of the present disclosure;

FIG. 6A is a hysteresis curve illustrating the Mullins effect for 0 vol. % composition at 50% and 100% strains for seven cycles, according to one embodiment of the present disclosure;

FIG. 6B is a hysteresis curve illustrating the Mullins effect for 40 vol. % composition at 50% and 100% strains for seven cycles, according to one embodiment of the present disclosure;

FIG. 7A is a line graph illustrating the results of cyclic uniaxial tension tests for thermal pads from 0-40 vol. % BN amount for 50% strain, according to one embodiment of the present disclosure;

FIG. 7B is a line graph illustrating the results of cyclic uniaxial tension tests for thermal pads from 0-40 vol. % BN amount for 100% strain according to one embodiment of the present disclosure;

FIG. 8A is a hysteresis curve illustrating the Mullins effect for 10 vol. % BN composition at 50% and 100% strains for seven cycles, according to one embodiment of the present disclosure;

FIG. 8B is a hysteresis curve illustrating the Mullins effect for 20 vol. % BN composition at 50% and 100% strains for seven cycles, according to one embodiment of the present disclosure;

FIG. 8C is a hysteresis curve illustrating the Mullins effect for 30 vol. % BN composition at 50% and 100% strains for seven cycles, according to one embodiment of the present disclosure;

FIG. 9 is a schematic diagram of the TIM system, further depicting the glassy phase, the rubbery phase, and the nanoparticle, according to one embodiment of the present disclosure.

FIG. 10A is a chemical diagram illustrating the functionalization of BN with polydopamine and 3-(aminopropyl)triethoxysilane (APTES), according to one embodiment of the present disclosure;

FIG. 10B is a schematic representation of a sample fabrication process through a spin coating technique, further depicting the annealed thin film transferred to a different substrate using a water assisted method after the base PAA layer dissolves in water for further characterization, according to one embodiment of the present disclosure;

FIG. 10C is a table illustrating non-limiting examples of the components used in the fabrication of the thin film system, and further depicting their functionality, according to one embodiment of the present disclosure;

FIG. 11A is a schematic diagram of a testing apparatus where PDMS is taken as the substrate and the thin film system is placed over it, according to one embodiment of the present disclosure;

FIG. 11B includes line graphs illustrating strain (%) versus time (s) for tension, compression, and cyclic tests, wherein for cyclic testing, a total of 100 cycles and one cycle represents one 10%, 20%, or 30% strain for both compressive and tensile tests, according to one embodiment of the present disclosure;

FIG. 12A includes brightfield optical microscopy images showing the morphology of i) PS with 15 vol. % BN ii) PI with 15 vol. % BN iii) 4.35:5.65 ratio of PS and PI polymer blend thin films with 15 vol. % of ar-BN, further depicting where the BN particles have agglomerated to form large asperities due to the poor dispersion of the nanoparticles, according to one embodiment of the present disclosure;

FIG. 12B includes TEM images showing morphology, dispersion, and localization of BN in the polymer blend at i) 0% BN, ii) 5% BN, iii) 15% BN, iv) 25% (by volume), further depicting at 0% BN, dark spots in the light PI phase are nanospheres of PS. BN observed at continuous PI and interface of PS/PI. Insets for v) 5% BN and vi) 25% BN showing that as the BN content increases in the blend thin film, an increase in contrast due to aggregation and increasing electron density was be observed, according to one embodiment of the present disclosure;

FIG. 13A includes an optical microscopy image showing the morphology of thin film of PS/PI at 15 vol. % of BN before test, during the test, and after 30% strain test for a compression test at 0% strain before deformation, after 50 cycles of 30% tension-compression strains, and after 100 cycles of 30% tension-compression strains, wherein the insets represent the same area of a particular film at different strains for a particular mechanical test, and wherein the mechanical testing was performed on thin films supported on PDMS substrates at ε=10%, 20%, and 30% for 0, 5, 15, and 25 vol. % BN.

FIG. 13B includes an optical microscopy image showing the morphology of thin film of PS/PI at 15 vol. % of BN before test, during the test, and after 30% strain test for morphology at 0% strain before deformation, after 50 cycles of 30% tension-compression strains, and after 100 cycles of 30% tension-compression strains, wherein the insets represent the same area of a particular film at different strains for a particular mechanical test, and wherein the mechanical testing was performed on thin films supported on PDMS substrates at ε=10%, 20%, and 30% for 0, 5, 15, and 25 vol. % BN.

FIG. 13C includes an optical microscopy image showing the morphology of thin film of PS/PI at 15 vol. % of BN before test, during the test, and after 30% strain test for a compression test at 0% strain before deformation, after 50 cycles of 30% tension-compression strains, and after 100 cycles of 30% tension-compression strains, wherein the insets represent the same area of a particular film at different strains for a particular mechanical test, and wherein the mechanical testing was performed on thin films supported on PDMS substrates at ε=10%, 20%, and 30% for 0, 5, 15, and 25 vol. % BN.

FIG. 14 includes a schematic representation of the deformation types observed during compression and tension tests, further depicting the thin films constituting PS, PI, and BN are subjected to 10%, 20%, and 30% strains under compression and tension. Under compression creases arise whereas on tension cracks form. The extent of deformation was shown to increase with the increase in strain;

FIG. 15 includes optical microscopy images showing the morphology of 30 vol. % ds-BN with PS/PI blend thin film, a) during compression. b) during tension. Images were taken at 0% strain before the deformation, at maximum 30% strain, and reversing the strain back to 0% strain. Mechanical testing of thin films was performed on PDMS substrate at ε=30% for tension and compression tests. Insets represent the enlarged images of the same area of a particular film at different strains;

FIG. 16A includes FTIR spectra for unfunctionalized versus functionalized BN nanoplatelets, further depicting strong labelled peaks for functionalized BN represent contributions from polydopamine and silane groups;

FIG. 16B includes SEM images showing morphology of BN before and after functionalization;

FIG. 17 is a line graph illustrating the thickness of thin films fabricated at varying concentrations of BN, measured through step height differences between PDMS and the thin films using optical profilometry (OP), further depicting an increasing trend in the film thickness was observed as the BN content increased, according to one embodiment of the present disclosure;

FIG. 18 includes optical microscopy images showing the morphology of PS/PI/BN before test (0% strain), during the test (10% compressive strain), and after test (˜0% strain), wherein the mechanical testing of thin films was performed on a pre strained Solaris substrate;

FIG. 19 includes optical microscopy images showing the morphology of PS/PI/BN before test (0% strain), during the test (10% tensile strain), and after test (˜0% strain), wherein the mechanical testing of thin films was performed on a pre strained PDMS substrate;

FIG. 20 includes optical microscopy images showing the morphology of PS/PI/BN taken at released stage of 0 cycles, 50 cycles, and 100 cycles of a 10% strain tensile-compressive cyclic test performed at 100 cycles, wherein the mechanical testing of thin films was performed on a pre strained Solaris substrate;

FIG. 21 includes optical microscopy images showing the morphology of PS/PI/BN before test (0% strain), during the test (20% compressive strain), and after test (˜0% strain), wherein the mechanical testing of thin films was performed on a pre strained Solaris substrate;

FIG. 22 includes optical microscopy images showing the morphology of PS/PI/BN before test (0% strain), during the test (20% tensile strain), and after test (˜0% strain), wherein the mechanical testing of thin films was performed on a pre strained Solaris substrate;

FIG. 23 includes optical microscopy images showing the morphology of PS/PI/BN taken at released stage of 0 cycles, 50 cycles, and 100 cycles of a 20% strain tensile-compressive cyclic test performed at 100 cycles, wherein the mechanical testing of thin films was performed on a pre strained Solaris substrate;

FIG. 24 includes optical microscopy images showing the morphology of PS/PI/BN before test (0% strain), during the test (30% compressive strain), and after test (˜0% strain), wherein the mechanical testing of thin films was performed on a pre strained Solaris substrate;

FIG. 25 includes optical microscopy images showing the morphology of PS/PI/BN before test (0% strain), during the test (30% tensile strain), and after test (˜0% strain), wherein mechanical testing of thin films was performed on a pre strained Solaris substrate;

FIG. 26 includes optical microscopy images showing the morphology of PS/PI/BN taken at released stage of 0 cycles, 50 cycles, and 100 cycles of a 30% strain tensile-compressive cyclic test performed at 100 cycles, wherein mechanical testing of thin films was performed on a pre strained Solaris substrate;

FIG. 27 includes optical microscopy images showing the morphology of thin film of PS/PI at 15 vol. % of unfunctionalized BN before test, during the test, and after 30% strain test for a) compression test b) tensile test, wherein the insets represent the same area of a particular film at different strains for a particular mechanical test; and

FIG. 28 is a flowchart depicting a method of fabricating a thermal interface material (TIM) system, according to one embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIG. is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The thermal interface material (TIM) system 100 of the present disclosure may include a thermal pad 102 having a thermoplastic elastomeric copolymer 104, 106 coupled to a thermally conductive nanoparticle 108. The thermoplastic elastomeric copolymer 104, 106 may include a glassy polymer 104 and a rubbery polymer 106, as shown in FIG. 9. In a specific example, the thermoplastic elastomeric copolymer 104, 106 may include a pseudo-bicontinuous morphology of polymer blends, such as polystyrene (PS) and/or polyisoprene (PI). The glassy phase 104 may be provided with PS while the rubbery phase 106 may be provided with PI. For instance, the polymer blend 104, 106 of PS and PI may include a ratio of around 4.5:5.5. In a more specific example, for a micron-scale TIM system 100, the thermoplastic elastomeric copolymer 104, 106 may include a triblock copolymer 110 of polystyrene-block-polyisoprene-block-polystyrene (SIS) as a morphology stabilizer. In an alternative example, for a nano-scale TIM system 100, polymer blend nanocomposites 112 may be utilized. In certain circumstances, the TIM system 100 may include benzophenone as a crosslinker 114. The thermally conductive nanoparticle 112 may include 2D boron nitride (BN) and/or any other similar non-electrically conductive but thermally conductive material. The thermally conductive nanoparticle 112 may be provided in various shapes and dimensions, such as spherical, nanoplatelets or nanotubes. In a specific example, the thermally conductive nanoparticle 112 may be provided as a sheet. In certain circumstances, the nanoparticle 112 may include a metallic filler material such as gold (Au). In a specific example, the percentage by weight of the thermally conductive nanoparticle 112 is from around 0.001% to around 62%. For instance, where the nanoparticle 112 is Au, the percentage by weight of the thermally conductive nanoparticle 112 is from around 0.001% to around 0.01%. In a more specific example, the percentage by weight of the thermally conductive nanoparticle 112 is from around 5% to around 40%, such as where the nanoparticle 112 includes BN. In certain circumstances, sheet may have a thickness of around 20-40 nm. One skilled in the art may select other suitable ways or materials for providing the TIM system 100, within the scope of the present disclosure.

To get a desired thickness of the TIM 100, the concentration of the polymers may be controlled. Around 2 wt. % polymer in solution was used to obtain the 100 nm thickness of the thin films. Below the thin film of polymer nanocomposite is the thin layer of polyacrylic acid that functions as a sacrificial layer on transferring the thin film during characterization. The polyacrylic acid (PAA) layer readily dissolves in the water bath that we utilize to isolate and manipulate the composite films.

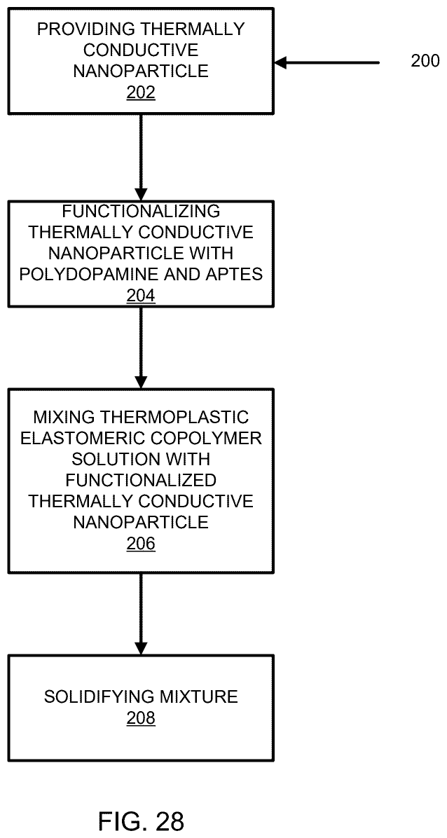

In certain circumstances, the TIM system 100 of the present disclosure may be provided in various ways. For instance, as shown in FIG. 28, the TIM system 100 may be manufactured according to a method 200. The method 200 may include a step 202 of providing a thermally conductive nanoparticle 112. Next, the method 200 may include a step 204 of functionalizing the thermally conductive nanoparticle 112 with polydopamine and 3-(aminopropyl)triethoxysilane (APTES). Afterwards, the method 200 may include a step 206 of mixing a thermoplastic elastomeric copolymer solution 104, 106 with the functionalized thermally conductive nanoparticle 112. In a specific example, the thermoplastic elastomeric copolymer solution 104, 106 may include a triblock copolymer 110 of polystyrene-block-polyisoprene-block-polystyrene (SIS). Then, the mixture 104, 106 may be solidified, thus providing the thermal interface material system 100. In a specific example, the step of solidifying the mixture may include casting the mixture into a mold and evaporating a solvent from the mixture. A skilled artisan may select other suitable ways to provide the TIM system 100, within the scope of the present disclosure.

In a specific, non-limiting example, the TIM system 100 of the present disclosure may be manufactured according to a spin coating technique. In a more specific example, the TIM system 100 has nano scale thickness so, spin coating is quicker, easier, and simpler. At first, on a clean and UV-ozone treated silicon wafer, thin layer of PAA, 6 wt. % dissolved on isopropyl alcohol, was spin coated. On top of it, a polymer blend nanocomposite solution was spin coated. The composite solution includes polystyrene (PS) 104 and polyisoprene (PI) 106, 2 wt. % of polymers in the ratio of 4.5:5.5 respectively, 20 wt. % of triblock copolymer 110 of polystyrene-block-polyisoprene-block-polystyrene (SIS) with respect to PI concentration as a morphology stabilizer, 5 wt. % of benzophenone with respect to total amount of polymers as a crosslinker 114, and gold nanoparticles 112 in toluene. The sample was then thermally annealed at 120° C. for 20 hours and treated with oxygen plasma to activate the benzophenone for crosslinking. Here, base layer of PAA assists in easy transfer of the thin film for the thermo-mechanical characterization. One skilled the art may select other suitable variances in weight percentage and material choice, within the scope of the present disclosure.

### Micron-Scale TIM System Example:

Provided as a non-limiting example, the TIM system 100 of the present disclosure was experimentally tested according to the following parameters.

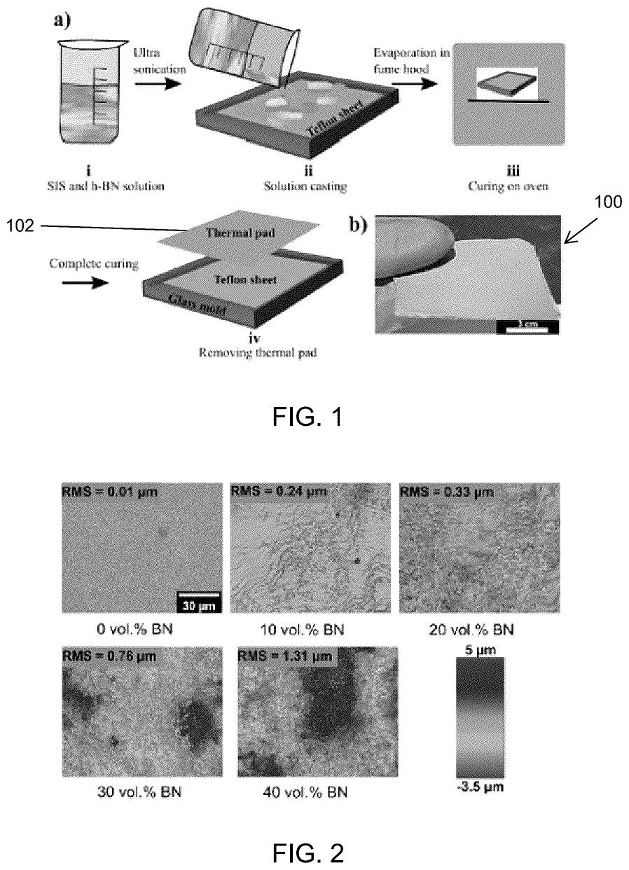

2D h-boron nitride (BN) of size 200-500 nm diameter and 20-40 nm thick were purchased from US Nanomaterials, US. They were functionalized with polydopamine followed by APTES. A solution of 12 wt. % of triblock copolymer of polystyrene-block-polyisoprene-block-polystyrene (SIS) purchased from Sigma Aldrich, USA was prepared using anhydrous toluene. 0, 10, 20, 30, and 40 volume % of BN (volume calculated based on dried state of SIS and BN) were added on the block copolymer solution. This is analogous to 0, 22, 39, 51, and 62% by weight, respectively. Then the mixture was magnetically stirred for 12 h followed by bath sonication for 2 h to ensure good dispersion and exfoliation of BN in the solution. A custom glass mold 1 mm thick with a base of a chemically resistant Teflon sheet was fabricated. The lateral dimensions were approximately 10 cm by 10 cm. The mixture of SIS and BN was cast in the mold and solvent evaporation took place in a fume hood for 12 h. Samples were further dried in a vacuum oven at 25° C. for 48 h. The details of sample preparation are represented in FIG. 1a. FIG. 1b shows thermal pad obtained through this process.

Optical profilometer (OP) (ZeScope, USA) with magnification of 40× was used to observe the top and bottom surfaces of the thermal pads formulated at different concentrations of BN. Surface roughness was measured and reported as Root Mean Square or RMS values. Thicknesses of the samples were measured using micro-calipers. Likewise, samples of each composite were cut into 1 cm by 1 cm squares to control the volume. Each square was then weighed to determine the average volume of each formulation.

A thermal gravimetric analyzer (TGA) with model TA Q50, TA Instruments, USA was used to study the onset of degradation and maximum degradation temperature of the composites. The tests were performed using nitrogen gas at a heating rate of 10° C./min from 25° C. to 800° C. Differential scanning calorimetry (DSC) was used to measure the specific heat capacity (Cp) of the composites using TA Q2000, TA Instruments, USA. ASTM Standard E1269-11 was followed to design the test parameters. Samples were held for an isothermal step at −20° C. for 600 s followed by heating at a ramp of 20° C./min to the maximum temperature of 250° C. and then held at isothermal heating at 250° C. for 600 s. 250° C. was chosen as the maximum based on the average onset of degradation temperature of the composites determined from TGA analysis.

In plane thermal conductivity was measured using laser-based Angstrom method. In this technique, a relatively thin sample (maximum 1 mm thick) is placed over the copper ring and an aluminum absorber is placed in the center of the sample. The sample is then heated with periodic laser pulses. Infrared (IR) camera is used to record the temperature response. Thermal conductivity is calculated based on this response along with values of density and specific heat capacity of the samples. Similarly, cross plane thermal characterization was performed using miniaturized reference bar method, a modified version of ASTM-D5470. Here the sample is inserted between two referential layers (Silica or Teflon sheet) of known thermal conductivity. A temperature gradient is induced by heating one side and keeping the other side cold. This gradient is recorded by the IR camera. The slope of the temperature versus distance data is used to calculate the cross-plane k values.

A universal mechanical tester (TA.XTPlus Connect, Texture Technologies Corp., USA) with 5 kg load cell was used to perform uniaxial tensile testing. Rectangular samples of approximately 16 mm length, 4 mm width and thickness were used in the mechanical testing. Elastic modulus was calculated from the initial linear region of the stress versus strain response. Shore A hardness is more commonly reported in the literature than the elastic modulus for thermal pads. It is derived from the elastic modulus using the formula:

$$E = \frac{0.0981 ( 56 + 7.62336 S )}{0.137505 ( 254 - 2.54 S )} \qquad ( 1 )$$

where, E is the elastic modulus and S is the ASTM D2240 shore hardness A.

To understand the material softening process, cyclic uniaxial testing was carried out at 50%, 100%, and 150% strains at 25° C. for 7 cycles per sample. Tests were performed at a low strain rate of 0.01 s⁻¹ with n=3 for each concentration of BN.

Microscopic roughness of electronic components leads to the formation of air pockets at the interface and can reduce thermal conductivity. Roughness could occur from the polymer or the filler. Block copolymers have nanometer scale domains, and the lateral resolution of the OP was insufficient to distinguish each polymeric domain. RMS roughness values were reported for each formulation. The top surface appeared rougher compared to the bottom surface molded against the sheet. This is mostly attributable to the influence of solvent evaporation. Roughness could also be affected by preferential migration of nanoparticles into the rubbery phase, to the interface of the immiscible polymers, or to the polymer-air interface. FIG. 2 shows the morphology of the top surfaces with their respective RMS roughnesses. With the increase in the amount of BN, the composite surface appeared rougher.

Given the same amount of SIS, increasing the amount of BN increases the thickness of the thermal pads. The average thicknesses for completely dried thermal pads are 110 μm, 130 μm, 195 μm, 220 μm, and 330 μm from 0 to 40 vol. % of BN, respectively. On a commercial scale, thermal pads have a thickness from 200 μm to up to a few millimeters (5-6 mm). The density values are determined to be 930 kg/m³, 1080 kg/m³, 1215 kg/m³, 1322 kg/m³, and 1481 kg/m³ from 0 to 40 vol. % of BN. These parameters are used in calculating the in plane and cross plane thermal conductivities.

From the DSC measurements, specific heat capacity (Cp) values are 3343 J/kg° C., 3499 J/kg° C., 4097 J/kg° C., 2971 J/kg° C., and 2213 J/kg° C., with increasing concentration of BN from 0 to 40%. The Cp increases from 0 to 20 vol. % of BN and decreases after 20 vol. %.

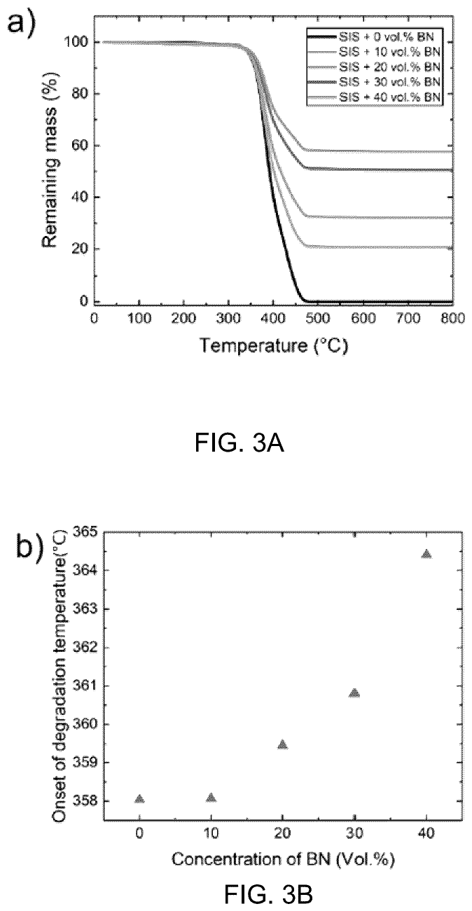

The TGA curve in FIG. 3a shows that after thermal degradation, the remaining mass of composites increases with the increase in BN addition. This makes sense as BN can withstand temperatures up to 1200° C. FIGS. 3a and 3b also depict that pure thermoplastic elastomer starts to degrade around 358° C. Pure thermoplastic elastomer completely burns after 470° C. The delay in onset of degradation is not very different among the compositions, changing by only 7° C. Degradation appears to be a one-stage process for all compositions. Overall, these thermal pads are highly thermally stable compared to the maximum temperature reached by electronics. The maximum degradation of the composites ranged from 380° C. to 383° C.

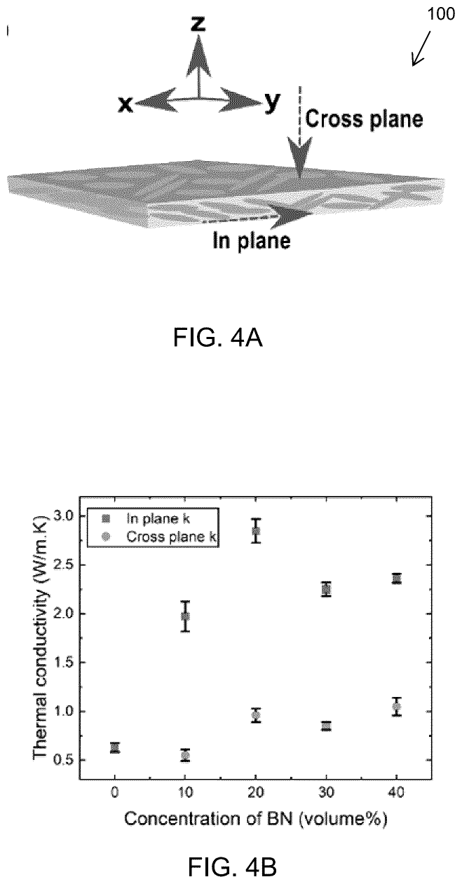

2D nanomaterials are inherently anisotropic. Thermal conductivity (k) can vary in both in plane and cross plane direction (FIG. 4A). 2D nanomaterials have lamellar structure. Their alignment parallel to this lamellar plane offers less thermal resistance as opposed to perpendicular stacking. In the perpendicular direction, out of plane vibration of molecules increases phonon-phonon scattering which increases as the thickness of the composites increases. FIG. 4b shows that for all compositions, in plane thermal conductivities are higher in contrast to the cross plane thermal conductivities. From 0 to 20 vol. %, we observed an increase in both in plane and cross plane k values. The percolation of BN could produce conductive paths in the composite. We found at 20 vol. % percolation threshold of BN is observed given constant amount of SIS in solutions. The k value is decreased above 20 vol. %. The polymer/filler and filler/filler interactions dictate conductivity, as opposed to the filler concentration alone. Thus, increasing filler concentration may not always improve conductivity if the interactions or morphology change. During sample fabrication, thermal pad formulations with dry BN concentrations above 20 vol. % were extremely viscous in the solution state. The drying of the viscous solution may not allow the nanoplatelets to rearrange into favorable morphologies that can increase thermal conductivity. A less viscous solution could allow for such percolated rearrangements.

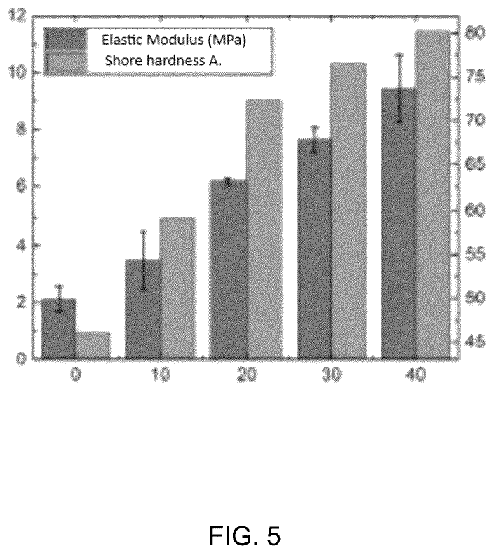

In normal operation, thermal pads can be subjected to up to 30% compression during cyclic thermal loading. Thermal pads with low elastic modulus are preferrable, so that they can easily conform to the flat, rigid surfaces they are bonding. FIG. 5 depicts the increase in elastic modulus values (of up to 4.5 times) from pure thermal plastic elastomer to up to 40 vol. % of BN. Shore A hardness is more commonly reported in the literature than the elastic modulus for thermal pads.

From the calculated elastic modulus, the Shore hardness values were equivalent to a range of 46-80 from 0 to 40 vol. % respectively.

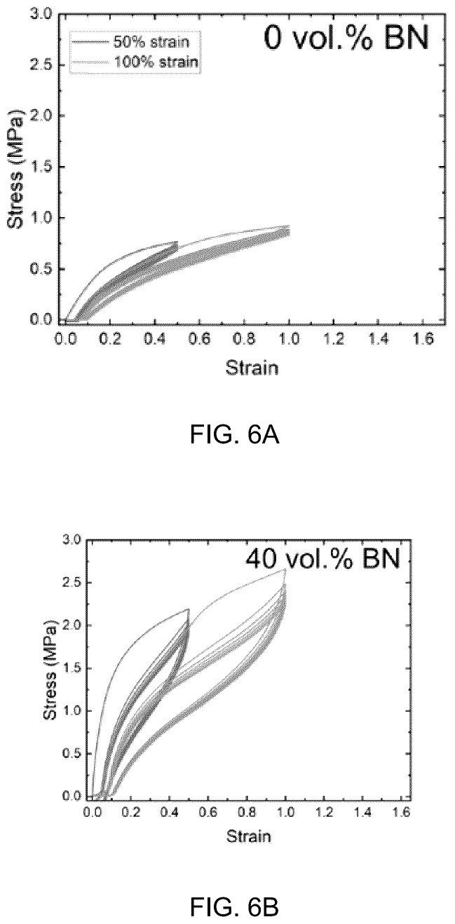

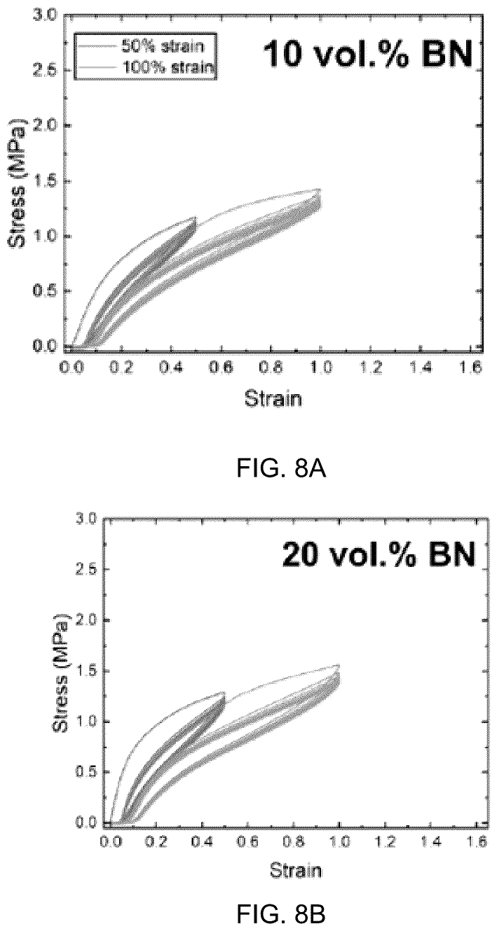

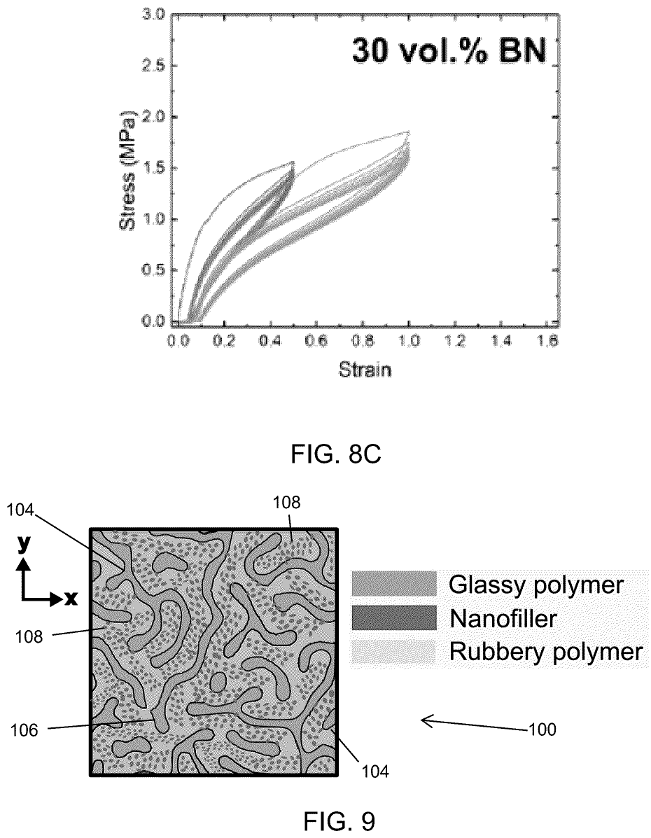

Hysteresis curves in FIG. 6 (0 and 40 vol. % BN) and in FIG. 8A-8C (10-30 vol. % BN) show that the first cycle of loading and unloading for all strains and formulations exhibits the highest hysteresis. This phenomenon is well explained as the Mullins effect that is dependent on the maximum strain level. Mullins effect is dependent on several factors such as: molecules slipping, bond breakage between fillers and polymer or in between polymer blocks, and disentanglement. Additionally, a smaller hysteresis was observed for all subsequent cycles due to the viscoelastic nature of the composites. For a system constituting stiffer and rubbery phases, rubbery phase highly deforms. Usually in the beginning cycle of loading-unloading of such materials, plastic deformation can occur in the stiffer materials that contributes to larger energy loss and residual deformation compared to the subsequent cycles. After the first cycle, the contribution from stiffer material is less. The stress is mostly acted upon along with higher deformation in the rubbery materials afterwards.

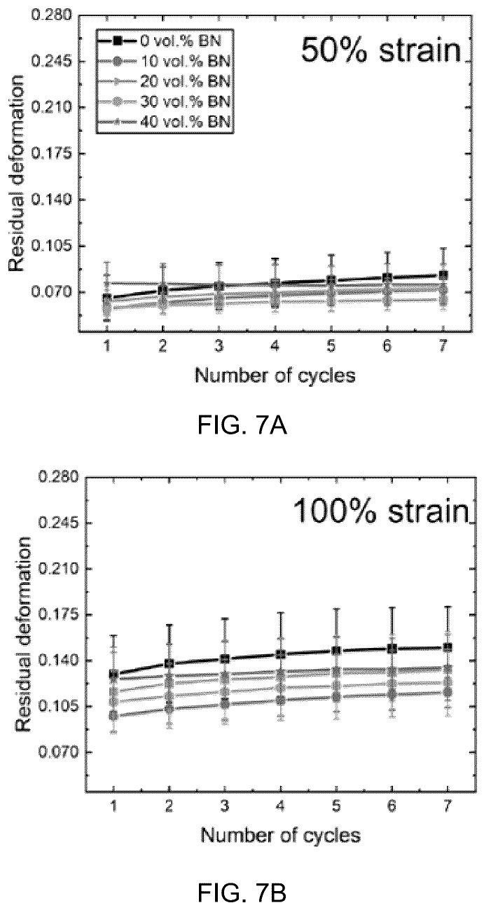

In FIGS. 7a and 7b, the residual deformation versus number of cycles results at different strain levels and concentration of BN are shown.

Residual deformation gives information on permanent deformation after each cycle. Residual deformation for 100% strain was higher than 50% strain. For 50% strain, this was below 10% for all compositions and seven cycles. Likewise, for 100% strain, this was below 15% composition for all compositions and seven cycles. We observed for a particular strain, these do not change much with the number of cycles and with respect to the composition. Even with Ecoflex, a type of commercially available silicone which is very soft and super stretchable, shore hardness of 00-50, under cyclic uniaxial tensile test residual deformation of up to 15% were observed. Ecoflex was stretched up to 500% in the study. The researchers explained residual strains are seen at the end of unloading even though the energy dissipation was observed to be negligible. A thermoplastic elastomer blend made from High impact polystyrene (HIPS) and Styrene-butadiene-styrene block copolymer (SBR) under uniaxial cyclic tension test showed permanent damage of nearly 20% at 150% strain. In practical applications, thermal pads undergo cyclic strains of up to 30%. We have tested the thermal pads more than three times of this strain in this study. The results obtained from the test show similar trend in residual deformation with respective to the other commercially available elastomers.

### Nano-Scale TIM System Example:

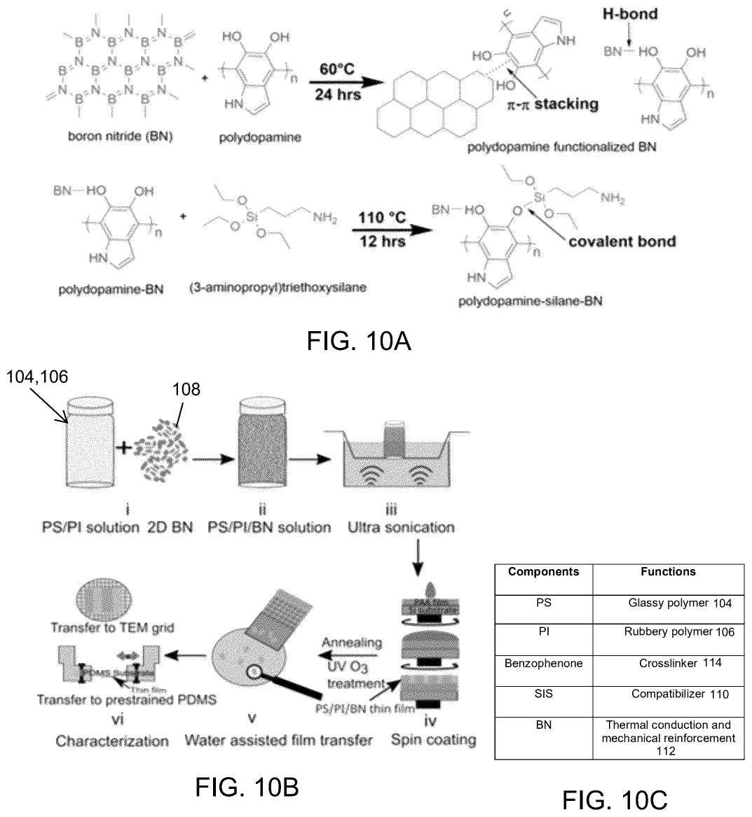

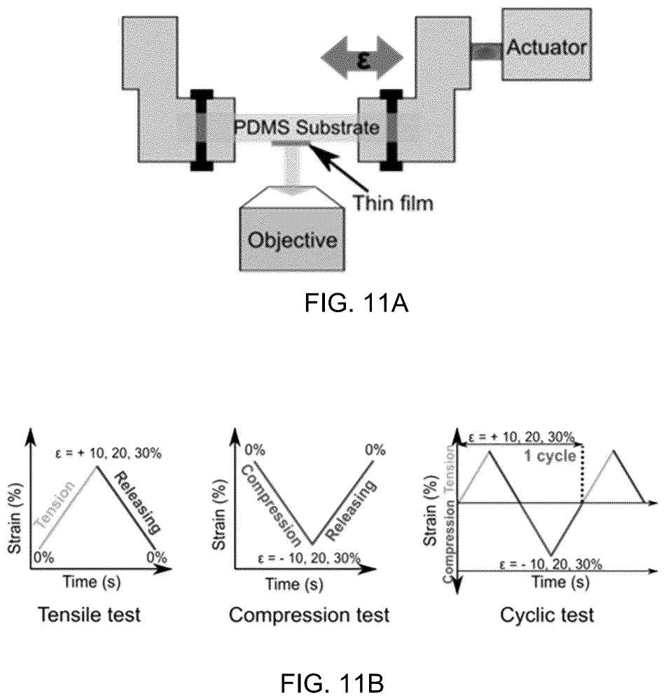

2D boron nitride (BN) nanoplatelets (200-500 nm diameter, 10-20 nm thickness) were obtained from US Research Nanomaterials, Inc. A Tris buffer solution (10 mM) was prepared and dopamine hydrochloride (1 g) was dissolved until a pH of 8.5 was obtained, turning the solution dark brown. BN (8 g) was added, magnetically stirred for 24 h at 60° C., vacuum filtered, and rinsed with deionized (DI) water. Polydopamine-BN was air-dried, then oven-dried at 100° C. for 12 h. The procedure for BN functionalization with polydopamine was followed from the work of Bruce, A. N.; Avins, H.; Hua, I.; Howarter, J. A. Enabling Energy Efficient Electronics Through Thermally Conductive Plastic Composites: Novel Surface Modification Techniques For Boron Nitride in Epoxy. Rewas 2016: Towards Materials Resource Sustainability 2016, 303-308. Polydopamine adds —OH groups on BN for silane attachment. The obtained polydopamine functionalized BN was further functionalized with APTES. At first, 0.15 g APTES (3 wt. % relative to polydopamine-BN) was mixed well in 250 ml anhydrous toluene. In the toluene and APTES solution, 3 wt. % of BN (7.5 g) was mixed and solution was stirred at 110° C. overnight. The resulting functionalized-BN was vacuum filtered, air-dried, and oven-dried at 100° C. for 12 hours. Rotary ball milling for 24 hours produced a fine powder of BN aggregates during drying. FIG. 10a illustrates the functionalization process.

In order to understand molecular interactions and chemical bonding, Fourier Transform Infrared (FTIR) spectra for functionalized BN with polydopamine (d-BN), with polydopamine-silane (ds-BN), and as received (ar-BN) were collected (PerkinElmer Spectrum 100 FTIR) in a transmission mode. Dried potassium bromide (KBr) pellets were made with a ratio of BN and KBr of 1:60. An average of 20 scans were taken with the wavenumber range of 4000-500 cm¹ in the spectrometer. Morphologies of unfunctionalized and polydopamine-silane treated BN were examined using Scanning electron microscopy (SEM, FEI Teneo Volumescope). Powdered BN samples were mounted on SEM stubs using adhesive carbon tape and sputter coated with platinum. Samples were imaged at 5 kV and 0.2 nA of beam current using an in-lens detector.

FIG. 10b depicts the fabrication of thin film nanocomposites. A solution of polystyrene (PS) (Mw=94,000 g/mol, Polymer Source, Inc.), cis-polyisoprene (PI) (Mw=30,000 g/mol, Scientific Polymer Products Inc.), styrene-isoprene-styrene (SIS) (22 wt. % styrene, Sigma Aldrich) triblock copolymer, and benzophenone (Mw=182.22 g/mol, Fisher Scientific) in anhydrous toluene was prepared. The blend contained 4 wt. % PS and PI (4.35:5.65 ratio), 20 wt. % SIS relative to PI, and 7 wt. % benzophenone relative to total polymers concentration. SIS acts as a compatibilizer 110 due to the similar structural units to the homopolymers, and benzophenone is a crosslinker 114 of PS and PI. The solution was filtered through a 0.1 μm syringe filter followed by addition of 5, 15, and 25 vol. % of BN. As a representative concentration, 15 vol. % of BN was added to each homopolymer solution to study the interaction of BN with PS and PI separately. Studies on interactions of 15 vol. % ar-BN and 30 vol. % ds-BN in the blend thin films were also performed. The nanocomposites solution was sonicated for one hour and filtered using 5 μm syringe filter to avoid large agglomerates. FIG. 10c illustrates all the components used in the thin film's fabrication process and their roles in the thin films.

Thin film nanocomposites, whether pure homopolymer or blends, were spin-coated on Silicon (Si) substrates. Si wafers underwent cleaning and oxygen plasma treatment (Glow Research). A 6 wt. % polyacrylic acid (PAA) solution in 70 v/v iso-propyl alcohol/water was spin-coated at 3000 rpm for 30 seconds and cured at 70° C. for 600 s. PAA being a hydrophilic polymer, acts as a sacrificial layer that dissolves in contact with water to facilitate the transfer of the upper thin film for further characterization. On the PAA layer, PS/PI/BN blends or homopolymer with BN were spin-coated at 3000 rpm for 60 secs. The spin-coated samples were dried in a room temperature vacuum oven for 24 hours and treated with UV Ozone for 10 minutes. As a photo initiator, benzophenone activates under UV Ozone treatment (UV/Ozone ProCleaner, BioSource Nanosciences). For observing BN dispersion in the thin film blend, Transmission electron microscopy (TEM, FEI Tecnai G2 20) was utilized. Nanocomposite thin film samples were transferred to 400 mesh copper grids for observation under TEM. The average polymer domain size was approximately 5 μm. At a 7000× magnification, all components in the system for various compositions were visible.

Poly dimethyl siloxane (PDMS) solid substrates for thin film uniaxial mechanical testing were prepared using Solaris (Smooth-On, Inc.) with a 1:1 ratio of part A (precursor) and part B (crosslinker). After vigorous mixing and degassing using an evacuated desiccator for 0.5 h, the mixture was poured into a 3 mm custom-built glass mold and cured for 24 h at room temperature. The cured PDMS was cut into 35 mm×10 mm×3 mm rectangular strips. The elastic modulus of the cured PDMS substrate is 0.32±0.05 MPa.

Optical microscopy was combined with a Psylotech TS micromechanical load frame featuring custom 3D-printed grips. Grips were placed 15 mm apart on a stand with the PDMS substrate held loosely between the grips. The load cell side was clamped first with the load value tared. Subsequently, the actuator side was clamped which deflects out of plane and creates a compressive force due to Poisson's effect. To counter this, the actuator was jogged precisely to a position where the force was zero. For compressive and cyclic tests, an additional 10% pre-strain on the intended strains of testing was applied before adhering the films. For tension tests, PDMS substrates were pre-strained by 10% regardless of any tensile strain.

After applying pre-strain to the PDMS substrate, thin film samples were transferred via water assisted method for characterization. To prepare films for transfer, Si wafer edges were scraped using a razor blade, creating roughly 2 mm square samples. The wafer, taped to a glass slide, was lowered into DI water, allowing the sample to float. Using a nichrome wire loop, the floated thin film samples were transferred to a PDMS substrate for mechanical testing.

For images of tension and compression tests taken on optical microscope during quasi-static testing, a reference feature was manually tracked in the same position during straining. Images were captured at 0% strain before test, at maximum strain, and upon releasing the strain back to 0%. The global strain rate was approximately 5×10⁻⁶ s⁻¹ for both tension and compression tests. Videos were recorded with images taken at 1% strain increments. Likewise, for images of cyclic tests taken during quasi-static testing on the optical microscope, a reference feature was manually tracked before testing, after 50 cycles of tension and compression, and after 100 cycles. The global strain rate for cyclic test was approximately 7×10⁻⁶ s⁻¹.

Optical profilometer (OP) (ZeScope) was further used to confirm the deformation of thin films observed in optical microscopy during tension and compression strains. A custom-built micromechanical stage with 3D-printed grips and manual linear stages facilitated the process. Similar to the loading for in situ mechanical test, the PDMS substrate was placed across a 15 mm gap between grips. As before, pre-strain was applied for compression tests until the substrate was nearly flat. Films were transferred to the top of PDMS, and the whole stage placed on the OP for imaging with a 20× objective at different strains. For topographic maps of tension and compression tests taken on the OP, a scan with identifiable feature as reference feature to manually track at different strains was acquired before the test. Then 10% strain was applied manually using a digital caliper, the identified feature relocated, and a second scan was acquired. The process was repeated in 10% increments to acquire maps for 0, 10, 20, and 30% strains. Scan parameters were adjusted on a scan-by-scan basis to obtain complete data. Thin film thickness was calculated based on step height differences between PDMS and thin films.

There are two major chemical steps for BN functionalization with polydopamine and APTES, as shown in FIG. 10a. Dopamine is catalyzed by Trizma base to form polydopamine by closing the amino ring. Catechol groups of dopamine oxidize to quinone forms and quinone self-polymerize to form a polydopamine coating layer around BN. 2D BN nanoplatelets are held together by weak vdW forces. BN interacts with polydopamine through 71-71 stacking (benzene ring of polydopamine interacts with the hexagonal ring of BN) and H-bonding. H-bonding occurs between the nitrogen atom of BN and the —OH group of polydopamine. Thus, an adherent polydopamine coating around the BN forms. Silane groups attach to BN-polydopamine by reacting with the —OH group, forming a covalent bond. Functionalized BN is localized in the continuous PI phase and at the interface. The functionalized ds-BN can react with cis-PI through hydroamination or via the addition of water to alkenes. The alkyl functional groups of silanes are compatible with non-polar polymers.

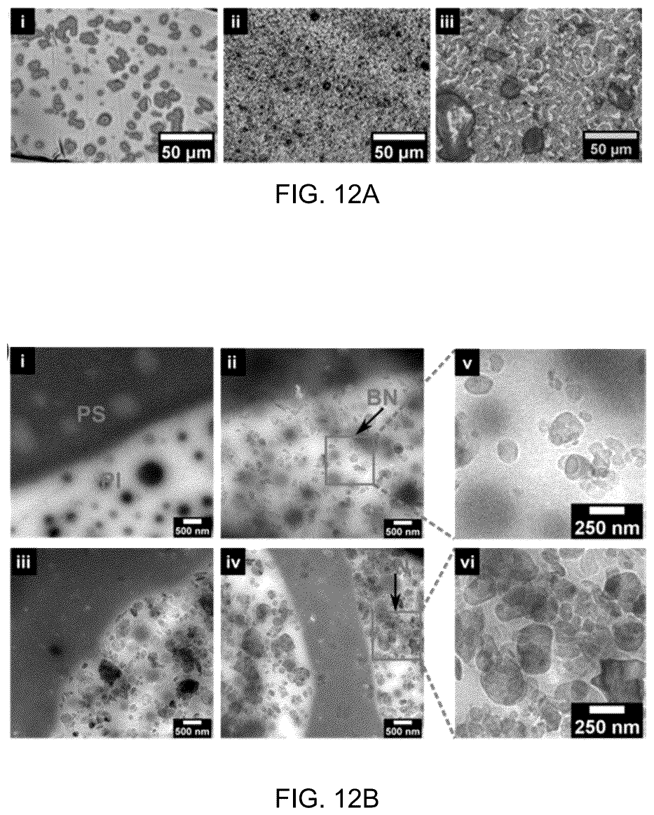

Disparities in the dispersion of ds-BN in homopolymer PS and PI matrices can be observed in FIG. 12a. In the pure PS matrix, BN exhibits poor dispersion, forming large dewetted regions when cast into thin films. Such dewetting regions serve as nucleation sites for void formation in thin films, causing uneven stress concentrations throughout the entire film. Wrinkles were observed in the film immediately after floating in water, indicating significant residual stress while on the wafer. Thus, PS and BN lack significant compatibility to form a stable nanocomposite film. In contrast, BN dispersed well in the PI homopolymer. Films of BN/PI were observed to be smooth and continuous with no holes via an optical microscope, maintaining their original dimensions upon floating in water. It has been reported that 20-30 wt. % of nanoparticle fillers in a rubbery matrix can provide reinforcement effect for improving mechanical properties.

Functionalization of BN nanoparticles was determined to be crucial to the effective dispersion within the PS/PI blend nanocomposites. In the thin film blends, ar-BN exhibited large agglomeration (FIG. 12a). 15 vol. % of ar-BN was used in the 4.35:5.65 PS/PI blend as a representative formulation. Large and accumulated BN asperities in the polyisoprene matrix were formed on using ar-BN. Voids emerged around these aggregations during fabrication acting as regions of stress concentration during mechanical testing. The inorganic ar-BN poorly bonded to the organic PI matrix and interface of PS and PI. Thus, the interface of ar-BN nanoplatelets and polymeric matrix was not compatible resulting in poor adhesion, dispersion, and distribution of ar-BN. Mechanical strength of these nanocomposites is based on the mobility of polymer chains and stress transfer from polymer to the nanofillers. However, using ds-BN in polymer blends resulted in well dispersed nanoparticles, primarily located in the PI portion of the films as shown in FIG. 12b. The rest of this paper will therefore focus on ds-BN incorporated at different concentrations in PS/PI thin films to visualize the localization of ds-BN within the nanocomposite and understand the mechanics of these thin films under various mechanical tests.

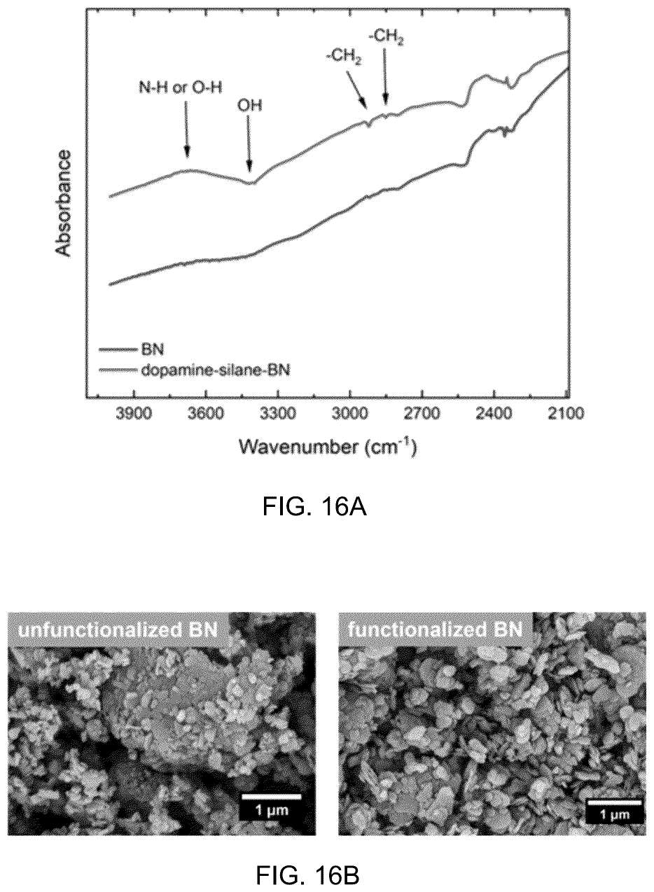

Functionalized BN nanoplatelets were compared to as received BN to contrast the differences in morphology or molecular interactions. SEM images in FIG. 16B show ar-BN forming thick, aggregated particle stacks, while ds-BN appears less layered and less aggregated. The relatively high surface energy of the BN nanoplatelets prior to functionalization can cause significant particle agglomeration. Functionalization modifies the surface so that the hydroxyl and silane groups bind to the surface of BN, reducing the interfacial energy between nanoplatelets. A contrast in the molecular interactions and bonding of ar-BN, d-BN and ds-BN was seen in the peaks above 2500 cm¹ in the FTIR image in FIG. 16A. Additional peaks for polydopamine and silane in the FTIR spectra was used to confirm successful surface functionalization of BN.

Understanding dispersion and localization of nanofillers in the pseudo-bicontinuous morphology of immiscible blends is important to tune mechanical toughness and vital properties of fillers such as thermal, electrical, or ionic conductivity. TEM images in FIG. 12b show each polymer phase and the dispersion of BN in the polymeric blend. PS has the darkest contrast and PI the lightest in the TEM images. Nanodroplets of PS with diameters ranging from 100 nm to 800 nm in the continuous PI phase were observed with TEM which were not visible with the optical microscope. TEM images also show the morphology, dispersion, and localization of BN at 5, 15, and 25 vol. % in the blend. The 2D nanoplatelet shape of BN is observable for all compositions. BN particles are localized in the continuous PI phase and at the interface of the PS/PI blend. Increasing the concentration of BN also increased the agglomeration of the BN, appearing as darker regions in the TEM images due to the increased electron density in the stacked regions. Insets in FIG. 12b show the differences in morphology at low (5 vol %) and high (25 vol. %) concentrations of BN.

Accurate prediction of the localization of nanoparticles in a polymer blend is challenging. Quantitatively, nanoparticle localization is predicted by the interfacial interaction of the nanoparticle with either of the polymers and between the two polymers governed by Young's equation. In other words, fillers localize in the polymer phase that has comparatively lower interfacial tension than the other polymer. However, kinetics and processing conditions can also impact nanofiller dispersion and localization. Brownian motion, shear-driven migration, and bridging-dewetting were identified to govern nanoparticles migration and localization. In a shear driven mechanism, both nanoparticles and dispersed polymer phase are under motion in the continuous polymeric matrix and can collide. The shear can lead to the migration of nanoparticles to either polymer depending on the compatibility. In the absence of shear, the movement of nanoparticles in a viscous polymeric matrix does not occur. A shear-driven dispersion mechanism may have further driven the localization of BN in our experiments. Nanoparticles tend to localize at the interface to reduce interfacial tension of the system and prevent coalescence. Here, both ds-BN and ar-BN are not compatible with PS, and localize in PI and the interface of PS and PI. Functionalization is improving the dispersion of BN nanoparticles.

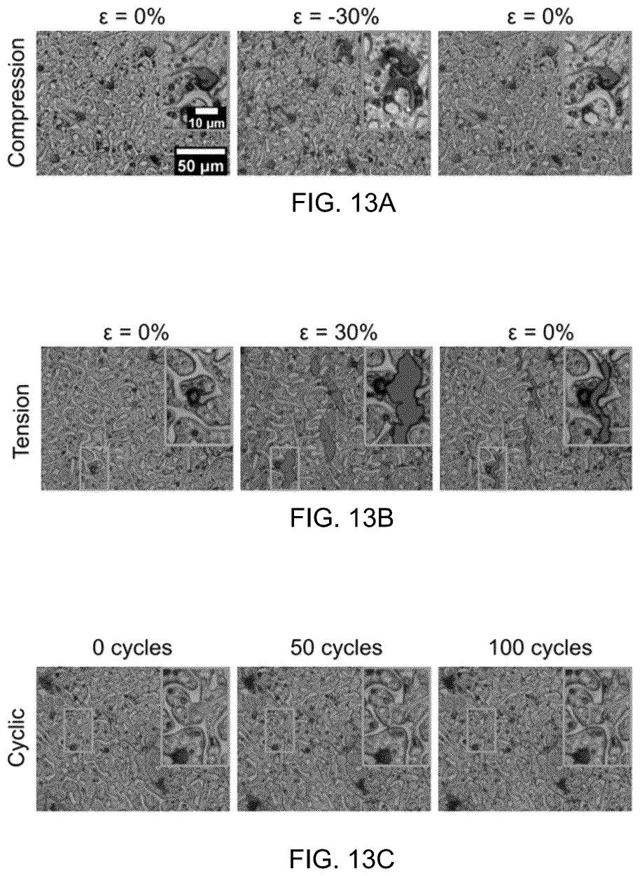

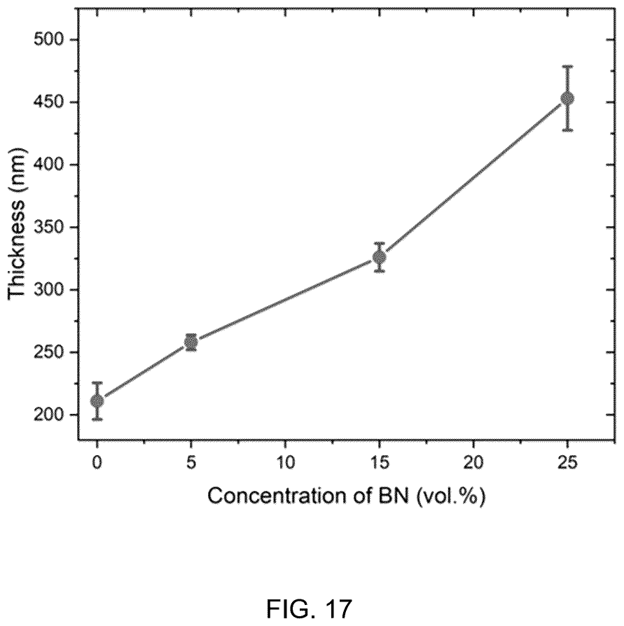

The morphology of the PS/PI blend thin films varied slightly as the concentration of BN changed. However, the pseudo-bicontinuous morphology with a continuous rubbery phase was preserved for all compositions. On these thin films constituting different BN concentrations (0-30 vol. %), the dispersed light region are PS, the continuous grey region is PI, and the dark spots indicate BN in optical microscopic images (FIG. 13). The increase in BN concentration has elevated both the size and quantity of these dark BN regions. At 25 vol. % BN, increased aggregation occurs, breaking up PS domains, and making the PS domains less continuous. The thickness of the polymer blend nanocomposite thin films increased with higher BN concentrations since the polymer concentration is constant for all compositions. FIG. 17 shows the thickness of thin films from 0-25 vol. % BN.

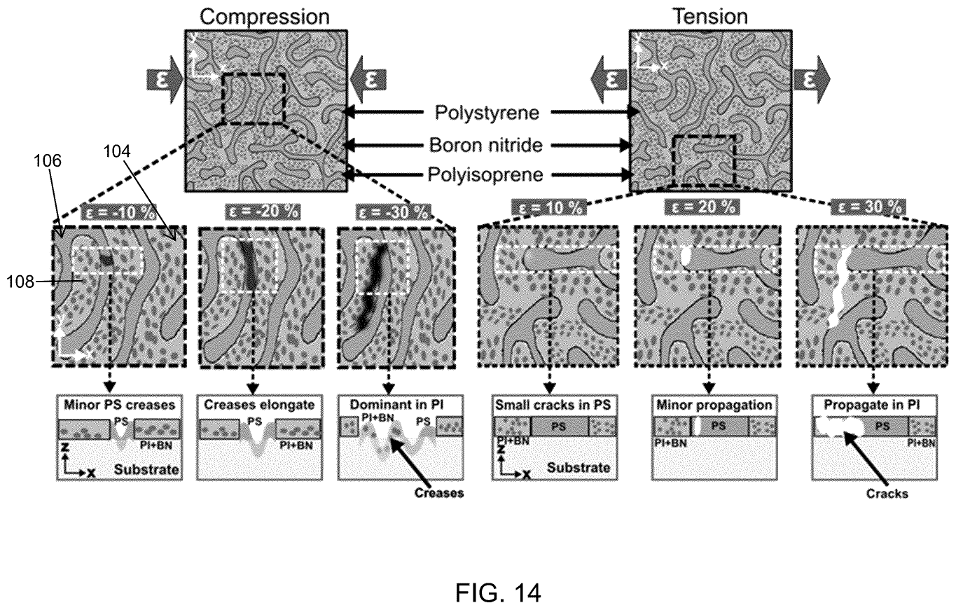

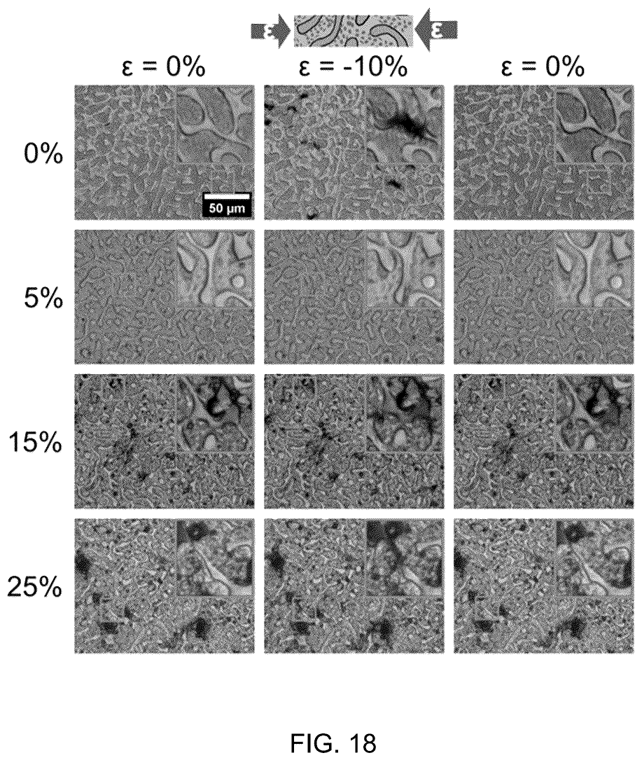

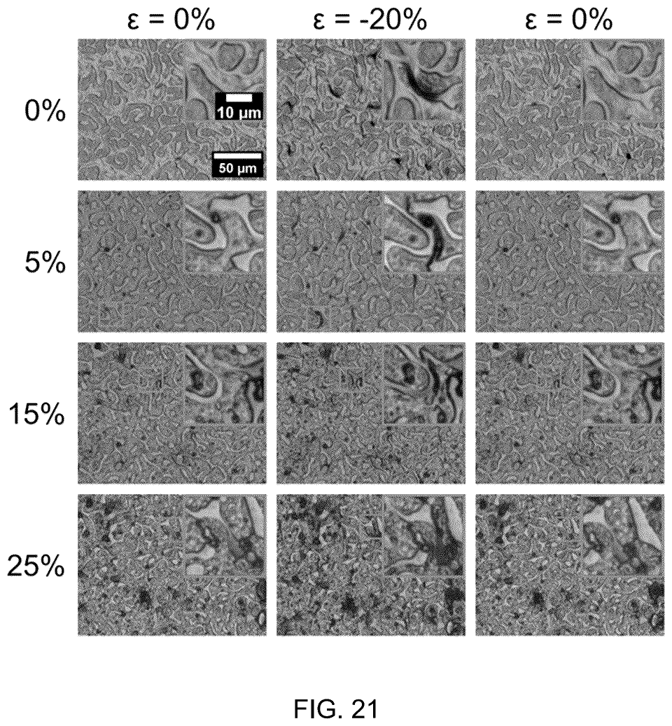

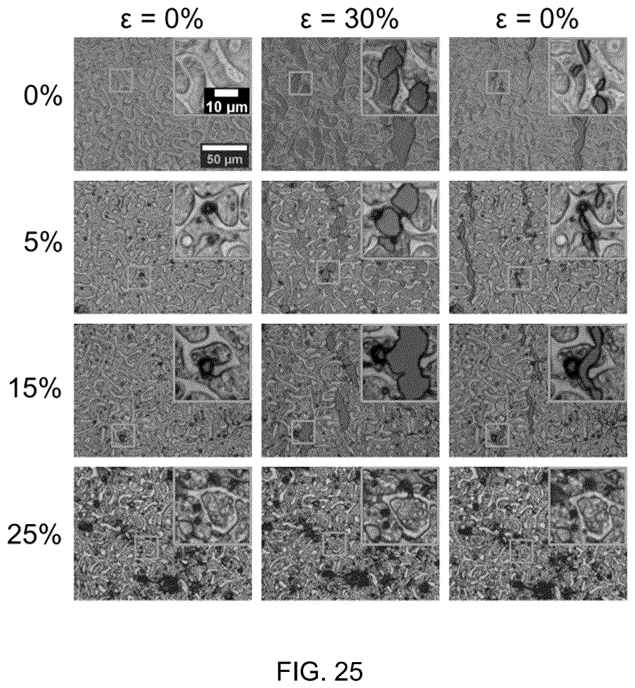

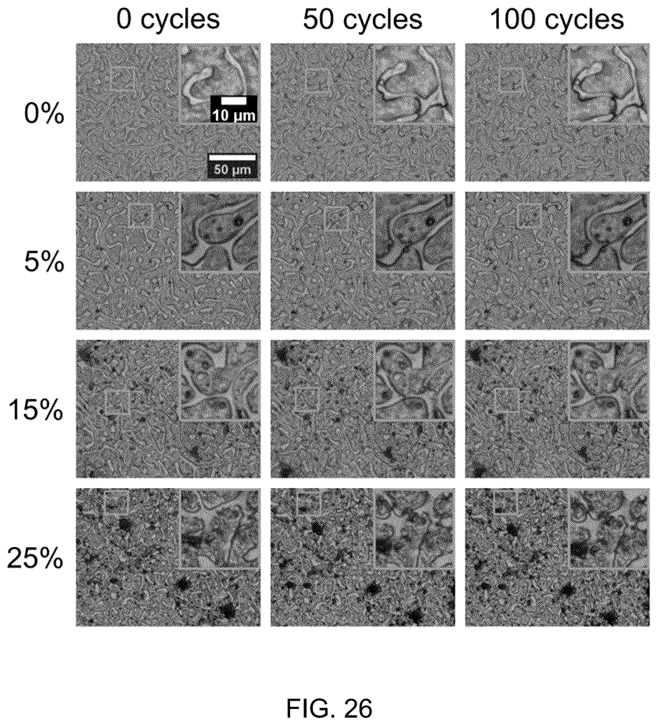

Unlike homopolymer system, the inclusion of nanofillers leads to deformation from the filler-polymer interface in the polymers imparted with high concentration of nanoparticles. FIG. 14 illustrates the morphology of blend thin films incorporated with 15 vol. % BN at 30% strains of compression, tension, and 100 cycles of cyclic tests. For compression (FIG. 13a) and tension tests (FIG. 13b), images are shown at 0% strain, 30% strain, and releasing back to 0% strain. For cyclic tests (FIG. 13c), images are shown at 0% strain before deformation, after 50 cycles of 30% tensile-compression strains, and after 100 cycles of 30% tension-compression strains. Images of all other compositions (0%, 5%, and 25%) and 10%, 20%, and 30% strains as well as 15 vol % with 10% and 20% strains are shown in detail in FIG. 18-26.

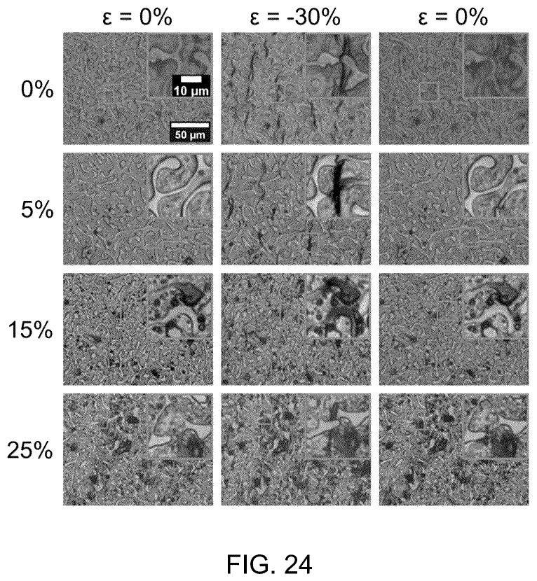

During a compression test, creases appeared that recovered fully upon reversing the strain direction back to 0% strain (FIG. 13). The creases mostly appeared and elongated along the perpendicular PS domains to the compression direction. At a few regions where the perpendicular creases to the compression direction meet on a parallel oriented PS domain, creases propagated to another PS domain along the continuous PI domain. This was notably evident for 0 and 5 vol. % BN where BN accumulation are sparse (FIG. 24). For a compressive force in a thin film, tension occurs along the orthogonal direction due to the Poisson effect. Out of plane buckling orthogonal to the compressive stress direction occurred in the form of out-of-plane deflection of large PS structures and creasing of PI over PS boundaries. The deflection of PS structures is dominant at smaller 10% strain, while the creasing of PI over PS is dominant at 30% strain. Delamination was absent, and creases were completely recoverable after releasing from 10 or 20 or 30% strains (FIGS. 18, 21, and 24). The strain released during folding or creasing is more localized, while global strain recovery depends on thickness and elastic modulus mismatch between thin films and the substrate. The insets with pink borders highlight creases oriented orthogonally to the compression. At 15 and 25 vol. % BN, where the BN concentration is high and agglomeration is more pronounced, creasing still occurs but becomes more difficult to discern due to the colocation of similarly dark regions of aggregated BN. Additionally, these creases are less elongated compared to lower concentration formulations but remain recoverable upon releasing the strain to 0%. The higher BN concentrations appear to reduce the formation of elongated creases. Very few creases were observed at 10% strain, all of which were completely recoverable, and a few creases observed at 20% strain were also fully recoverable.

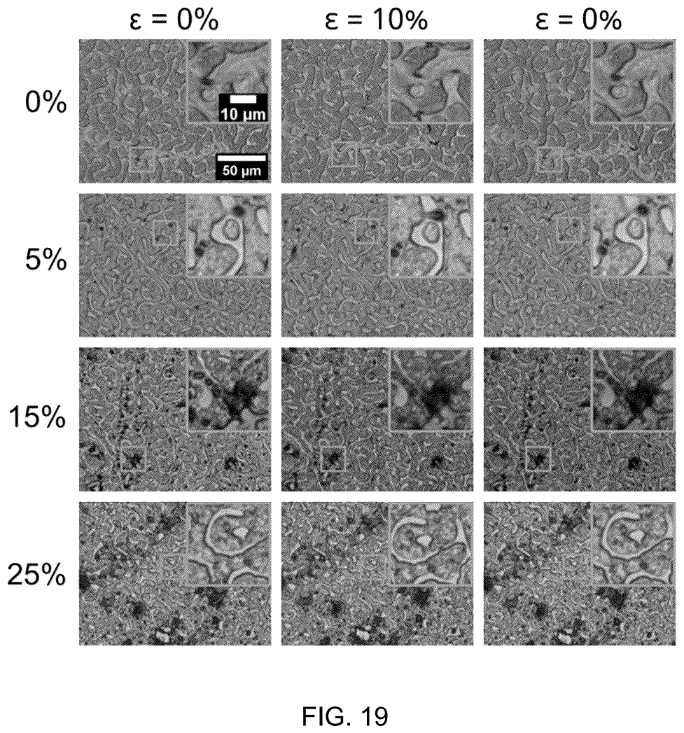

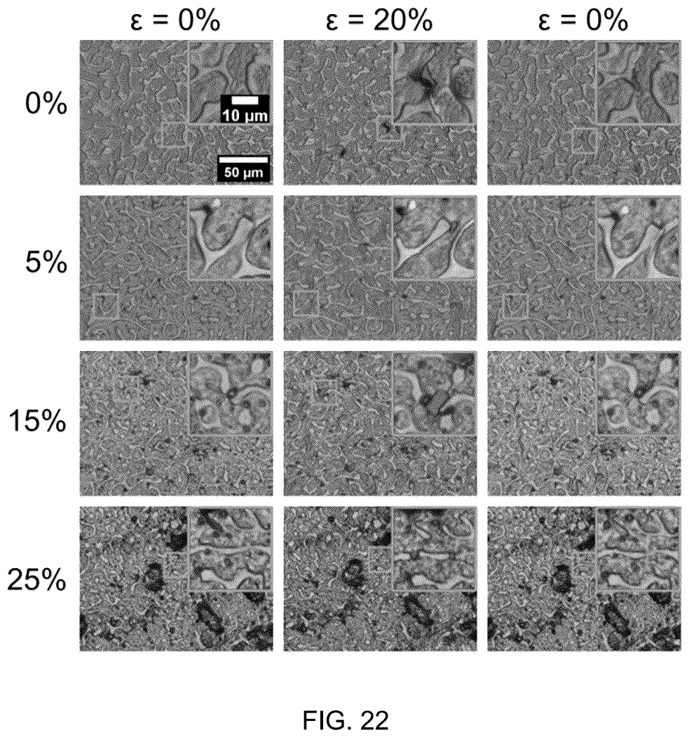

Unlike compression, tension tests resulted in a different deformation mechanism. Under tension, the Poisson effects on the substrate induced compression of the films orthogonal to the stretching direction, leading to Mode I fracture that propagates perpendicularly as depicted in FIG. 13b. Mode I fracture involves the opening and propagation of cracks perpendicular to an applied tensile force. Cracks initiated from the brittle PS domain and propagated perpendicularly through the rubbery PI domain and along the edges of PS regions. The rubbery PI, having a higher fracture toughness and elastic recovery, prevents significant deformation in the glassy PS domain. Polymer chains around the nanoparticles deform during a mechanical stretch. For glassy polymers, under the mechanical stretch, nanoparticles can segregate and align in the precraze regions. At 10% strain, cracks form in the PS, but do not propagate through the PI. At 20%, a small amount of propagation begins. At 30% strain, the cracks propagate through the PI matrix. From 0 to 15 vol. % of BN, crack propagation intensifies with the increase in BN concentration. The formation of a crack in the PI matrix releases internal stresses, allowing the PI to retract. Such cracks, therefore, are not recoverable when decreasing the strain back to 0%. The cracks expand the most at 30% tension due to the large internal stress of the strained PI region. No crack propagation is observed at 25 vol. % due to reinforcement of the thin films by BN. Having a high concentration of nanofillers in a rubbery matrix can prevent crack propagation by hindering the motion of the crack tip. 2D BN can reinforce the polymer attributable to the high elastic modulus and aspect ratio. Minimal cracks formed at 10% strain are completely recoverable (FIG. 19) and largely recoverable cracks were observed at 20% strain as shown in FIG. 22.

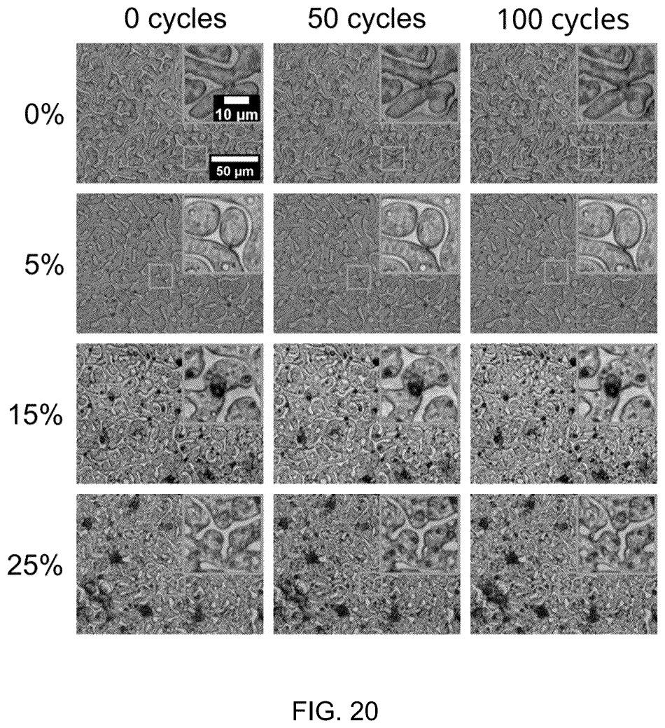

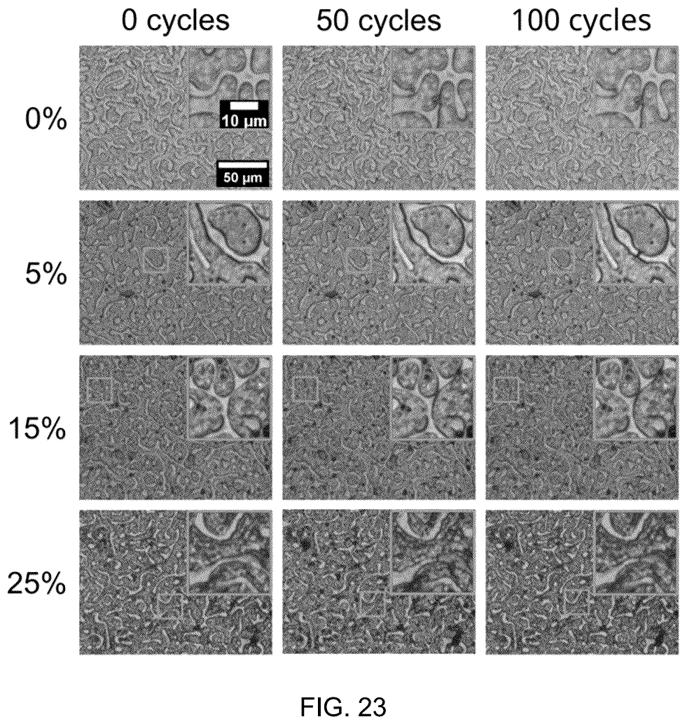

During the cyclic test, tensile stress is developed orthogonal to the compression direction, and compressive stress is developed orthogonal to the tension direction, leading to both deformation types (creases and cracks). The images for all cyclic tests were captured at 0% strains: before deformation, after 50 cycles, and after 100 cycles of 10%, 20%, and 30% strain tension-compression cycles. Cracks were formed at varying strains, appearing in the same location during each subsequent cycle after they formed. The already-formed cracks closed fully in most cases when returned to 0% strain, then opened again at very low tensile strain and grew with increasing strain. This behavior suggests that the closed cracks do not fully bond together, but simply make contact, so this material is not self-healing. The nanocomposite is, however, mechanically resilient as these cracks reached a maximum size at 30% tension that was consistent across all cycles, do not grow further, and most close when returned to 0% strain. As cyclic tests progressed, some new cracks formed but most formed within the first cycle. The regions most vulnerable to cracking are segments of PS that are parallel to the loading axis. Creases during compression form orthogonally to these segments, forcing them to bend out of plane. These regions act as stress concentration sites during tension. During an isolated compression test, without applying a tensile force to open a crack, this effect is not visible. During an isolated tension test the cracks are not completely recoverable in the PI. However, during a cyclic test, further compressing the thin film after releasing from tension allows for more relaxation time for the rubbery PI to partially recover. As shown in the inset figures in 13c, minor effects are seen in the PS in a few regions which are the points of crack initiation where PS seem to be disconnected. The extent of damage is affected by the degree of strain. At 100 tension-compression cycles of 10% and 20% strains, lesser damage was observed that was recoverable as shown in FIGS. 20 and 23. A clearer schematic representation for each deformation formed under tension and compression as we change the strains from 0% to 30% in the thin films is depicted in FIG. 14. The in-plane and through-plane appearance of creases and cracks are also represented.

The films exhibited localized deformations during tension or compression shown by the OP height images for all compositions as observed with in situ mechanical testing. Overall, the mechanical integrity of these thin films has been preserved irrespective of the high loadings of BN up to 25 vol. % and up to 30% strain attributable to the dispersed stiffer phase and continuous elastomeric rubber. PS, being a stiffer polymer, limits total deformation in the system during mechanical testing. Likewise, the elastomeric PI phase absorbs strain energy through in-plane elastic deformation. With a low glass transition temperature (T_{g}) below room temperature, the PI phase remains highly extensible during normal operation, promoting molecular interactions and accommodating mechanical damage for improved adhesion. Additionally, PI has a low elastic modulus mismatch with the PDMS substrate.

Even with functionalized ds-BN, concentrations above 25 vol. % led to increased BN agglomeration in thin films accompanied by voids around the agglomerates as shown in FIG. 14. At high nanoparticles density, the adherence of nanoparticles with the rubbery matrix can be poor resulting in voids at the interface occluding polymers in the aggregates negatively affecting mechanical properties. Such an interfacial failure can be a limiting factor to further add BN for mechanical or other functional enhancement. Compared to spherical fillers, non-spherical fillers with their lower packing density can have a larger void volume in between the fillers. This behavior, observed in 30 vol. % ds-BN, is similar to that which was observed using a lower 15 vol. % concentration of ar-BN.

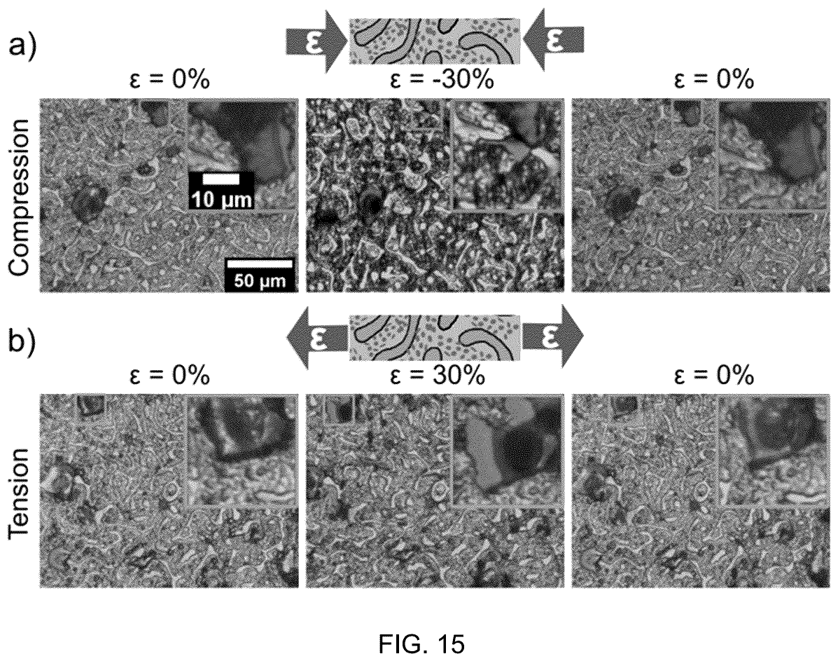

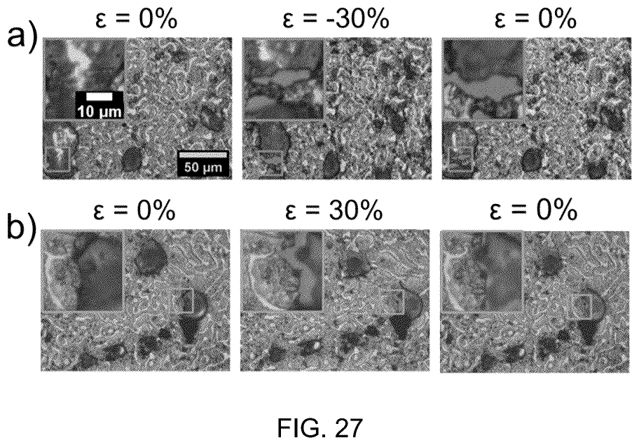

Despite these voids, during mechanical testing there was no complete material rupture or failure by embrittlement attributable to the elastomeric PI phase and possibly strong interaction of BN with the polymeric matrix. Compression resulted in out-of-plane buckling of PS domains in the form of creases, particularly those aligned parallel to the compressive directions (FIG. 15a). The voids around agglomerates appeared smaller as the PDMS substrate beneath the thin films deforms resulting the voids in thin film to compress during cycle. While the creases recover on releasing from maximum strains, the voids, especially those around agglomerated sites, persist and return to their original shape. Similarly, during tension, voids elongate as the PDMS substrate beneath the thin films elongates (FIG. 15b). On releasing back, some plastic deformation occurs shown by the insets. No other deformations were observed besides the elongation of these voids during tensile force. Similar mechanical performance was revealed by the thin films incorporated with lower i.e., 15 vol. % concentration of ar-BN. The morphological images during 30% strains of tension and compression tests are shown in FIG. 27 since the behavior was similar to the thin films with 30 vol. % ds-BN. Hence functionalization of BN plays an important role in morphology stabilization during processing that ultimately has impacts on the functional properties. Interfacial failure around the agglomerates of BN in continuous PI occurs rather than the deformation observed on applying mechanical strains.

Accordingly, the present disclosure includes novel polymeric materials selection to enhance both thermal and mechanical performance with the goal of designing the next generation of thermal pads. By utilizing glassy and rubbery polymers 104, 106, the mechanical robustness in the system 100 has been enhanced. In these novel materials, understanding the interactions of filler/filler and filler/polymer matrix is essential to improve overall performance of thermal pads. It was found that above 20 vol. % of BN nanoplatelets 112, there was not much improvement in thermal performance. In addition, higher filler content can lead to embrittlement with mechanical failure at fewer cycles and increased modulus. It is also contemplated that the present disclosure may be utilized to extend the processing to a solvent-free technique and to optimize the particle incorporation methods. Desirably, the present disclosure may provide an elastically recoverable thin film system 100 by integrating a pseudo-bicontinuous morphology with a crosslinked continuous rubbery PI phase 104 and dispersed stiffer PS phase 106 and localizing high loading of nanoparticles 112 in the continuous PI and interface of PS and PI.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A thermal interface material system comprising:
a thermal pad including a thermoplastic elastomeric copolymer coupled to a thermally conductive nanoparticle.

2. The thermal interface material system of claim 1, wherein the thermoplastic elastomeric copolymer includes a pseudo-bicontinuous morphology of polymer blends.

3. The thermal interface material system of claim 2, wherein the pseudo-bicontinuous morophology of polymer blends includes a rubbery polymer and a glassy polymer.

4. The thermal interface material system of claim 3, wherein a rubbery polymer includes at least one of polyisoprene (PI) and polybutadiene (PB).

5. The thermal interface material system of claim 3, wherein a glassy polymer includes at least one of polystyrene (PS) and polymethylmethacrylate (PMMA).

6. The thermal interface material system of claim 3, wherein the pseudo-bicontinuous morophology of polymer blends includes polystyrene (PS) and polyisoprene (PI).

7. The thermal interface material system of claim 6, wherein the polymer blend of PS and PI are provided in a ratio of around 4.5:5.5, respectively.

8. The thermal interface material system of claim 3, wherein the thermally conductive nanoparticle is non-electrically conductive.

9. The thermal interface material system of claim 8, wherein the thermally conductive nanoparticle includes 2D boron nitride (BN).

10. The thermal interface material system of claim 8, wherein the thermally conductive nanoparticle includes gold (Au).

11. The thermal interface material system of claim 3, wherein the percentage by weight of the thermally conductive nanoparticle is from around 0.001% to around 62%.

12. The thermal interface material system of claim 3, wherein the percentage by weight of the thermally conductive nanoparticle is from around 5% to around 40%.

13. The thermal interface material system of claim 6, wherein the thermally conductive nanoparticle is provided as a nanoplatelet having a thickness of around 10 nm-40 nm and the fabricated thermal interface material has a thickness from around 100 nm-1 mm.

14. The thermal interface material system of claim 6, wherein the thermally conductive nanoparticle is provided as a sheet having a thickness of around 20-40 nm.

15. The thermal interface material system of claim 1, wherein the thermoplastic elastomeric copolymer includes a triblock copolymer of polystyrene-block-polyisoprene-block-polystyrene (SIS).

16. A method of manufacturing a thermal interface material system, the method comprising the steps of:
providing a thermally conductive nanoparticle;
functionalizing the thermally conductive nanoparticle with polydopamine and 3-(aminopropyl)triethoxysilaneri-amino ethoxy silane (APTES);
mixing a thermoplastic elastomeric copolymer solution with the functionalized thermally conductive nanoparticle; and
solidifying the mixture, thus providing the thermal interface material system.

17. The method of claim 16, wherein the thermoplastic elastomeric copolymer solution includes triblock copolymer of polystyrene-block-polyisoprene-block-polystyrene (SIS).

18. The method of claim 16, wherein the thermoplastic elastomeric copolymer solution includes a pseudo-bicontinuous morphology of polymer blends.

19. The method of claim 16, wherein the step of solidifying the mixture includes casting the mixture into a mold and evaporating a solvent from the mixture.

20. The method of claim 16, wherein the step of solidifying the mixtures includes a spin coating technique.
